(19) United States
(12) Patent Application Publication
(10) Pub. No.: US 2025/0384336 A1
(43) Pub. Date: Dec. 18, 2025

(54) GENERATING MODEL OUTPUT EXPLANATIONS USING ARTIFICIAL INTELLIGENCE-BASED PROCESSING OF DATA STRUCTURES

(71) Applicant: Dell Products L.P., Round Rock, TX (US)

(72) Inventors: Abhishek Mishra, Bangalore (IN); Anuj K. Chitalia, Mumbai (IN)

(21) Appl. No.: 18/746,429

(22) Filed: Jun. 18, 2024

(51) Int. Cl. G06N 20/00; G06N 3/045

(52) U.S. Cl. CPC G06N 20/00; G06N 3/045

(57) ABSTRACT

Methods, apparatus, and processor-readable storage media for generating model output explanations using artificial intelligence-based processing of data structures are provided herein. An example computer-implemented method includes obtaining at least one machine learning model output generated by processing at least one set of user input data; generating one or more values attributed to the machine learning model output(s), wherein each of the one or more values indicate a relative impact of a given variable, among one or more variables, on the machine learning model output(s); generating at least one explanation of the at least one machine learning model output by processing at least a portion of one or more data structures comprising the generated value(s), using one or more artificial intelligence techniques; and performing one or more automated actions based on the generated explanation(s) of the machine learning model output(s).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In many machine learning model applications, the internal workings of the machine learning models can present significant challenges to user understanding and trust of the machine learning model outputs. Users, even those with technical backgrounds, often find it difficult to comprehend the basis on which a particular machine learning model arrives at a specific output, and conventional artificial intelligence approaches fail to adequately remedy such difficulties. Accordingly, such conventional approaches often result in a lack of machine learning model transparency, which can undermine user confidence and/or user trust in the corresponding machine learning model(s).

### SUMMARY

Illustrative embodiments of the disclosure provide techniques for generating model output explanations using artificial intelligence-based processing of data structures.

An exemplary computer-implemented method includes obtaining at least one machine learning model output generated by processing at least one set of user input data, and generating one or more values attributed to the at least one machine learning model output, wherein each of the one or more values indicate a relative impact of a given variable, among one or more variables, on the at least one machine learning model output. The method also includes at least one explanation of the at least one machine learning model output by processing at least a portion of one or more data structures comprising the one or more generated values, using one or more artificial intelligence techniques. Additionally, the method includes performing one or more automated actions based at least in part on the at least one generated explanation of the at least one machine learning model output.

Illustrative embodiments can provide significant advantages relative to conventional artificial intelligence approaches. For example, problems associated with undermining user confidence and/or user trust in machine learning models are overcome in one or more embodiments through automatically generating machine learning model output explanations using artificial intelligence techniques to process machine learning model-related data structure values.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for generating machine learning model output explanations using artificial intelligence-based processing of data structures in an illustrative embodiment.

FIG. 2 shows an example workflow in an illustrative embodiment.

FIG. 3 shows an example use case involving an illustrative embodiment.

FIG. 4 shows example pseudocode for evaluating Shapley (SHAP) values in an illustrative embodiment.

FIG. 5 is a flow diagram of a process for generating machine learning model output explanations using artificial intelligence-based processing of data structures in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

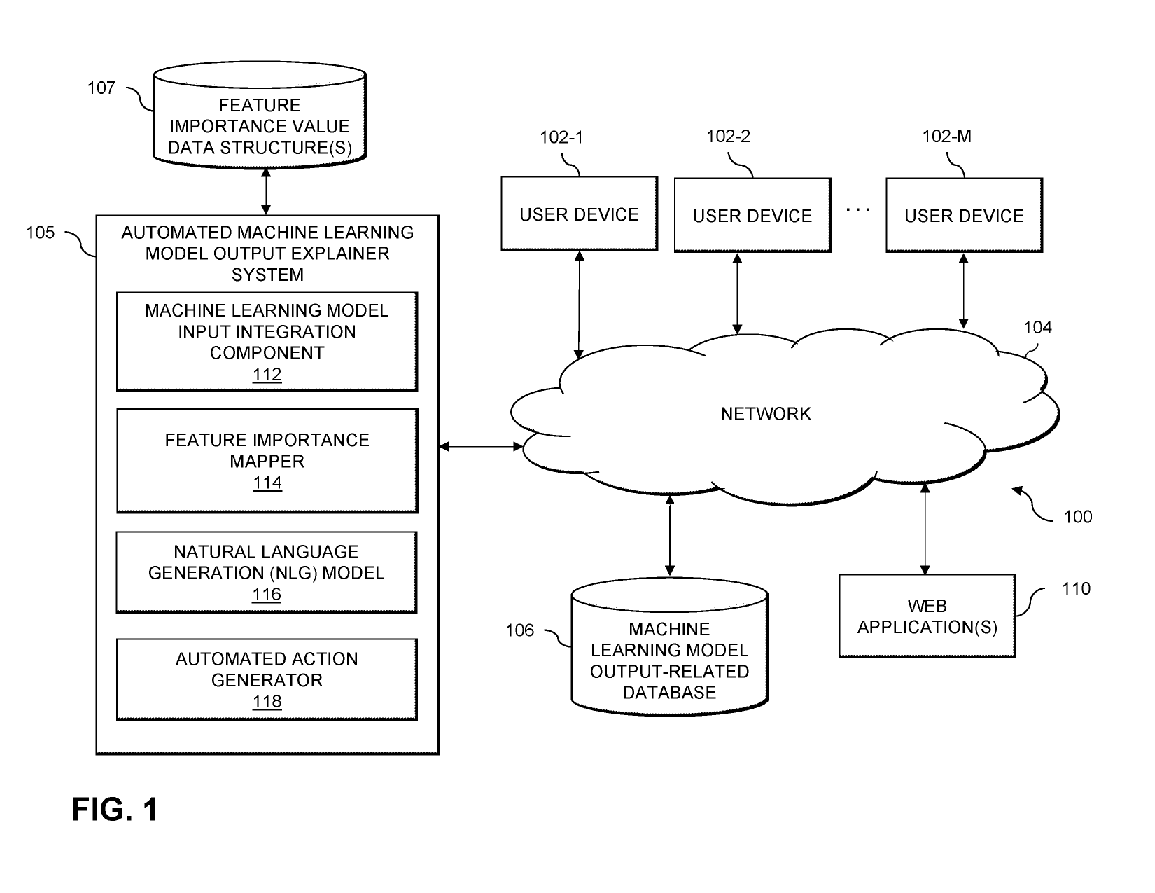

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated machine learning model output explainer system 105 and one or more web applications 110 (e.g., one or more e-commerce applications, one or more sports-related web applications, one or more output prediction applications, etc.).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated machine learning model output explainer system 105 can have an associated machine learning model output-related database 106 configured to store data pertaining to machine learning model outputs such as, e.g., input features, input data, model parameters, model prediction values, etc. Also, as depicted in FIG. 1, the automated machine learning model output explainer system 105 can have one or more feature importance value data structures 107 configured to store data pertaining to values (e.g., SHAP values) related to relative impacts of given variables on machine learning model outputs. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The machine learning model output-related database 106 and/or feature importance value data structure(s) 107 in the present embodiment is implemented using one or more storage systems associated with the automated machine learning model output explainer system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated machine learning model output explainer system 105 are one or more input-output devices, which illustratively comprise keyboards, displays or other types of input-output devices in any combination. Such input-output devices can be used, for example, to support one or more user interfaces to the automated machine learning model output explainer system 105, as well as to support communication between the automated machine learning model output explainer system 105 and other related systems and devices not explicitly shown.

Additionally, the automated machine learning model output explainer system 105 in the FIG. 1 embodiment is assumed to be implemented using at least one processing device. Each such processing device generally comprises at least one processor and an associated memory, and implements one or more functional modules for controlling certain features of the automated machine learning model output explainer system 105.

More particularly, the automated machine learning model output explainer system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated machine learning model output explainer system 105 to communicate over the network 104 with the user devices 102, and illustratively comprises one or more conventional transceivers.

The automated machine learning model output explainer system 105 further comprises a machine learning model input integration component 112, feature importance mapper 114, a natural language generation (NLG) model 116, and an automated action generator 118.

It is to be appreciated that this particular arrangement of elements 112, 114, 116 and 118 illustrated in the automated machine learning model output explainer system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for generating model output explanations using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated machine learning model output explainer system 105, machine learning model output-related database 106, feature importance value data structure(s) 107, and web application(s) 110 can be on and/or part of the same processing platform.

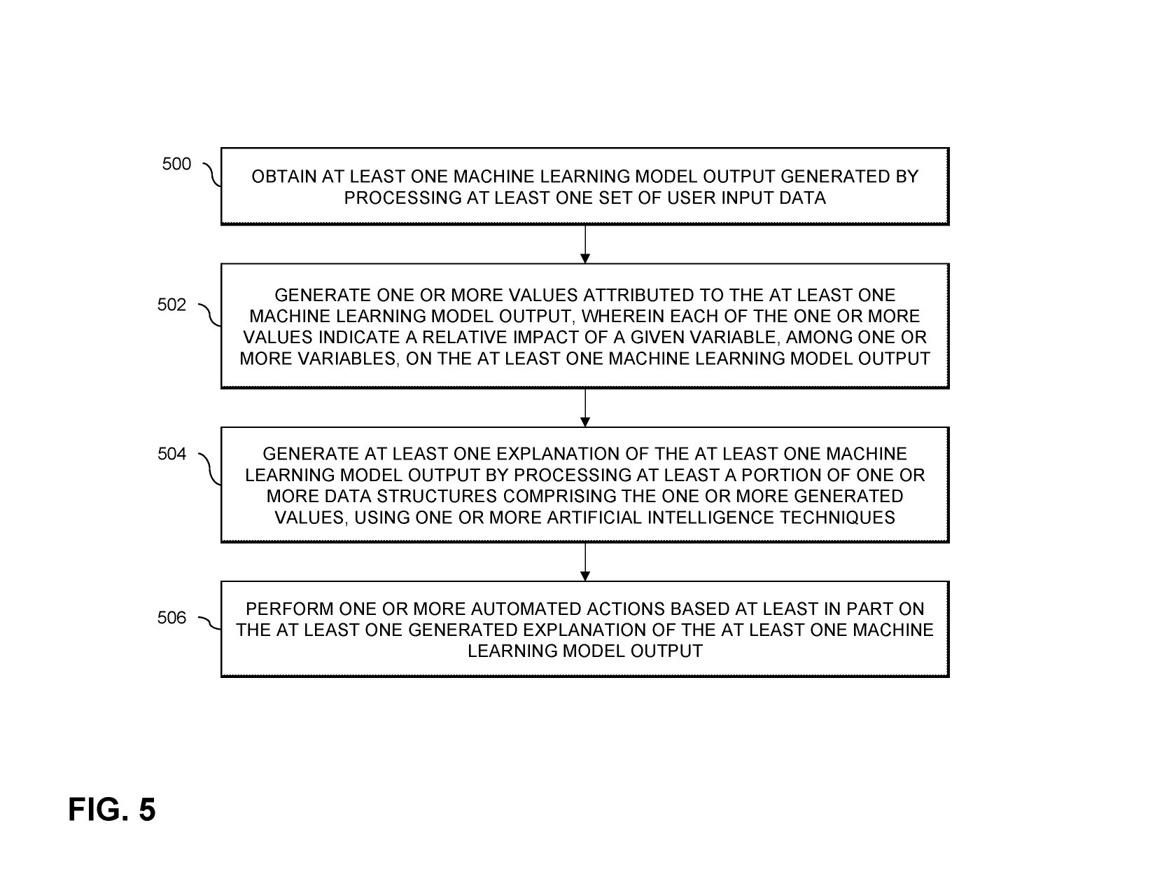

An exemplary process utilizing elements 112, 114, 116 and 118 of the automated machine learning model output explainer system 105 in computer network 100 will be described in more detail with reference to the flow diagram of FIG. 5.

Accordingly, at least one embodiment includes enhancing transparency and explain-ability in connection with machine learning models. As detailed herein, such an embodiment includes leveraging SHAP additive explanation values to determine and/or learn the impact(s) of input features on machine learning model outputs (e.g., machine learning model predictions). For example, integrating SHAP values into an NLG model (such as, e.g., a large language model (LLM)) facilitates automatically generating human-readable explanations that articulate the factors influencing the machine learning model’s output(s).

By way of illustration, and as used herein, a SHAP library is a tool which can be used to indicate and/or explain the output of machine learning models. More particularly, in one or more embodiments, SHAP values quantify the contribution of each of multiple features to the prediction of a particular instance in a machine learning model. In such an embodiment, the SHAP values can be utilized to facilitate and/or ensure a fair distribution of the machine learning model prediction by considering multiple (e.g., all) possible combinations of features. For example, for each feature, the SHAP value can be calculated by considering all possible subsets of features (also referred to, e.g., as coalitions) that could include the feature. In such a scenario, the SHAP value for a feature is the average of the feature’s marginal contributions across all possible coalitions. The marginal contribution is the difference in the machine learning model’s prediction when the feature is included versus when the feature is excluded. Additionally, in one or more embodiments, SHAP values can facilitate and/or ensure that the contribution of each feature is fairly distributed by averaging over all possible scenarios or coalitions.

As detailed herein, SHAP values can provide a measure of the importance of each feature for a particular machine learning model prediction, allowing a user to see which features are driving the machine learning model’s decision. Accordingly, SHAP values can offer transparency into the decision-making process of complex machine learning models, such as ensemble methods (e.g., random forest, gradient boosting, etc.), neural networks, etc. SHAP values can also help to explain individual machine learning model predictions, making it easier to understand and/or trust specific outputs of the machine learning model. Further, in one or more embodiments, by aggregating SHAP values across multiple instances, insights can be derived and/or gained into the overall importance of one or more features for an entire dataset.

Accordingly, at least one embodiment provides machine learning model users with one or more interpretable insights into the decision-making mechanisms of machine learning models. Additionally, one or more embodiments include flexibility sufficient to adapt to diverse artificial intelligence architectures and integrate with existing machine learning models, ensuring broad applicability across various domains and/or industries. Further, such an embodiment enhances user comprehension of machine learning model decision-making, fostering trust and informed decision-making in the deployment of machine learning models.

As described herein, one or more embodiments include incorporating and/or utilizing a machine learning model input integration component, a feature importance mapper, an NLG model, and an automated action generator (which can include, for example, an explanation aggregator and an explanation application programming interface (API) module). In such an embodiment, the machine learning model input integration component computes SHAP values for each of one or more input features of a given machine learning model, wherein the SHAP values represent the contribution of each feature to the machine learning model’s output (e.g., prediction). The input features of the given machine learning model can be identified, for example, during a machine learning model development phase. For instance, in machine learning model development, exploratory data analysis and feature engineering can be performed to identify a set of input features for machine learning model training. Additionally, the machine learning model input integration component, in conjunction with the above-noted computations, can capture the raw output of the given machine learning model for a given input.

Also, in at least one embodiment, the feature importance mapper maps at least a portion of the SHAP values, computed by the machine learning model input integration component, to one or more corresponding input features of the machine learning model, establishing an understanding of the importance of each of the input features in the machine learning model’s output and/or decision-making related thereto. Further, in such an embodiment, the NLG model translates at least a portion of the feature importance information, determined in connection with the actions of the feature importance mapper, into human-readable explanations. By way of example, the NLG model (e.g., an example of an explanation aggregator) can be designed and/or configured to generate explanations in one or more of multiple languages that is understandable and/or selected by one or more users.

Additionally, in one or more embodiments, and as noted above, the automated action generator can include an explanation aggregator and an explanation API module. In such an embodiment, the explanation aggregator leverages the SHAP values computed by the machine learning model input integration component and the output(s) of the NLG model to automatically generate one or more explanations for at least one output (e.g., at least one prediction) of the given machine learning model.

In other words, in one or more embodiments, a final output can be reached as follows. A user provides at least one input value to a machine learning model, which processes the at least one input value and predicts an output. SHAP values are then generated using the machine learning model prediction/output and designated input features of the machine learning model. Using the SHAP values, the designated input features, and the machine learning model prediction/output, a prompt is generated containing such data as well as one or more instructions for an LLM model to generate a final output indicating at least one explanation for the machine learning model prediction/output.

By way merely of example, consider a scenario wherein a machine learning model generates a prediction/output of “The weather will be sunny today.” In such an example, SHAP values might indicate that the token “sunny” was influenced by features such as temperature, humidity and time of day. One or more embodiments can include using the machine learning model input features and the corresponding SHAP values combined with the machine learning model prediction/output to create a prompt for an LLM (e.g., a generative pretrained transformer (GPT), bidirectional encoder representations from transformers (BERT), etc.). The response from the LLM can indicate that the machine learning model predicted “sunny” because the temperature was high and the humidity was low.

Also, at least one embodiment can include converting at least a portion of the feature importance information into plain language, emphasizing the one or more input factors that most influenced the machine learning model’s output. Also, in at least one embodiment, the explanation API module is implemented to provide, to one or more users, the machine learning model output(s) in conjunction with the generated explanations for easier and/or enhanced integration.

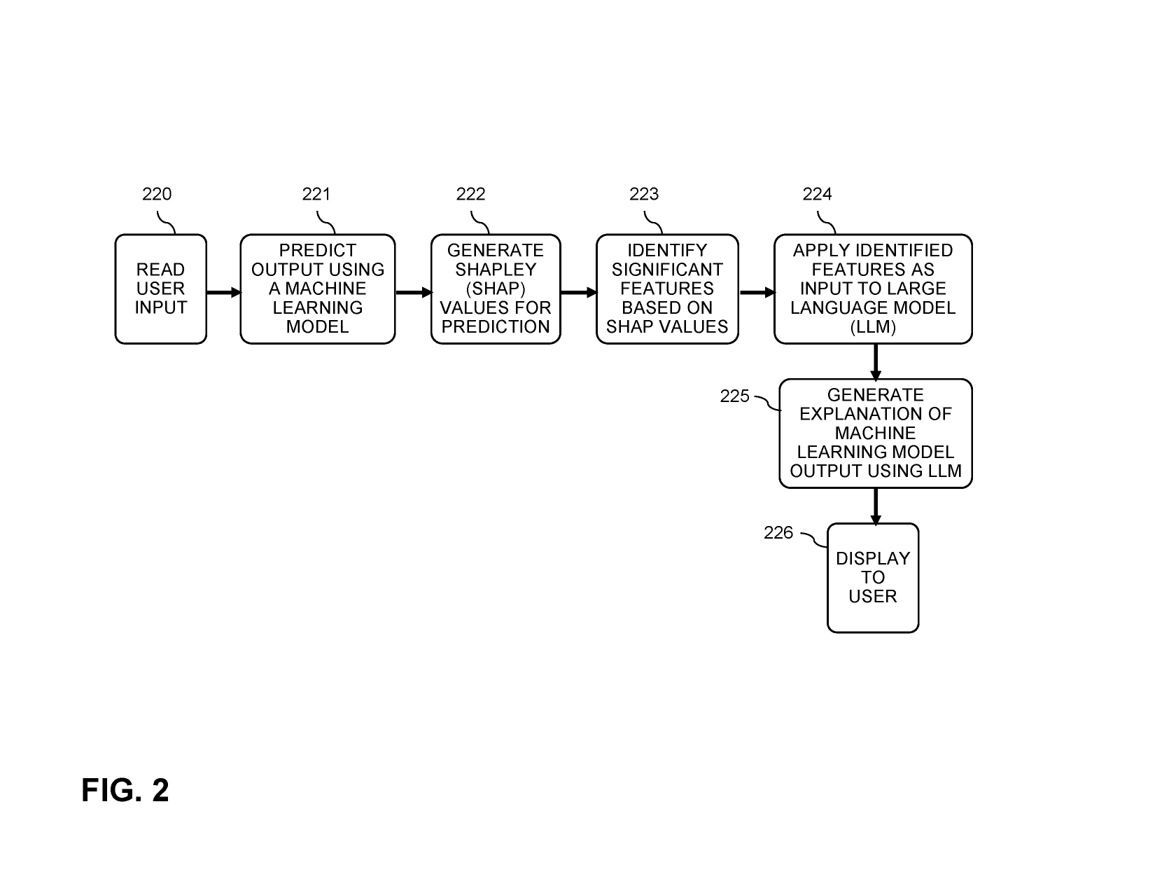

FIG. 2 shows an example workflow in an illustrative embodiment. By way of illustration, step 220 includes reading user input values (e.g., a user query for a machine learning model) and applying one or more data preprocessing techniques to convert the user input values into at least one model-compatible format. In step 221, a given machine learning model (e.g., an existing pre-built machine learning model) is used to generate an output for the given user input. In step 222, SHAP values are generated for the generated output using at least one SHAP library.

In one or more embodiments, the types of data that can be processed, generated, and/or leveraged in connection with a SHAP library can include feature importance and/or impact values (e.g., SHAP values), machine learning model input data, machine learning model output data, summary data, visualization data, interaction values, and/or background data. More particularly, SHAP values can serve as a primary output of a SHAP library, and such values quantify the contribution of each of multiple features to the prediction for a particular machine learning model instance. Machine learning model input data can include feature values, which can represent input data that was used to train the machine learning model and for which explanations are being generated. Such data can include multiple (e.g., all) features (e.g., independent variables) of the corresponding dataset. Machine learning model output data can include one or more predictions, which represent and/or include the predicted values and/or probabilities generated by the machine learning model for the given inputs. Also, summary data can include aggregated SHAP values, which can be used for visualizing overall feature importance across many instances. Such data can also include, for example, summary plots, dependence plots, and/or interaction plots, which illustrate how features impact the machine learning model’s predictions on average.

Additionally, visualization data can be used for plotting, and can include various datasets and/or intermediate computations required to generate visual explanations, such as summary plots, force plots, dependence plots, etc. Interaction values can include, e.g., SHAP interaction values, which extend SHAP values to capture interactions between features, showing how pairs of features jointly contribute to the prediction. Also, background data can include, e.g., background samples, which can be used to define the expected value of the machine learning model output. Background samples can also be selected from a training dataset and/or another representative dataset to define a baseline for SHAP value computation.

Referring again to FIG. 2, in step 223, the generated SHAP values are mapped against respective features of the machine learning model, and the most significant features of the machine learning model responsible for output (e.g., the features which exhibited the most influence on the output) are identified. In step 224, the user input and the identified SHAP values are used to fine-tune at least one LLM model to learn and/or understand a specific domain related to the user input and/or the machine learning model output. In step 225, an explanation of the machine learning model output is generated using the fine-tuned LLM (e.g., by processing the identified SHAP values using the fine-tuned LLM), and in step 226, the explanation is output and/or displayed to at least one user (e.g., the user who provided the initial user input values in the first step).

By way merely of illustration, consider the following example use case involving a sporting event between Team A and Team B. In this context, a given machine learning model predicted, before the game, a 60% probability of Team A winning, and a 40% probability of Team B winning. However, the actual outcome of the game contradicted this prediction, with Team B winning the game. Further, the discrepancy between the machine learning model’s forecast and the actual outcome may raise questions about the factors influencing the prediction, and emphasizes the need for an interpretable system that can explain the features contributing to such deviations, enhancing transparency and user understanding.

As such, in accordance with one or more embodiments, the original output of the given machine learning model (i.e., a 60% probability of Team A winning, and a 40% probability of Team B winning the upcoming game), can be supplemented with an automatically generated explanation of one or more factors influencing that prediction. For example, such an explanation might include the following:

“This optimistic outlook for Team A is primarily driven by exceptional performances from key players including Player-1 and Player-2, with their forecasted performances collectively adding approximately 20% to the overall Team A probability. Additionally, Player-3 and Player-4 are also forecasted to play a crucial role, with their performances contributing approximately 15% to Team A’s probability. Further, forecasted defensive performance by Team A increased the probability by approximately 5%, and recent victories in other games contributed another approximately 10% to Team A’s probability. On the flip side, the absence of key players due to injuries negatively impacted Team B’s probability, reducing the probability by approximately 8%. In summary, the machine learning model suggests that Team A’s strong defensive skills and individual player performances, along with recent team successes, position Team A as the likely winners in the upcoming game.”

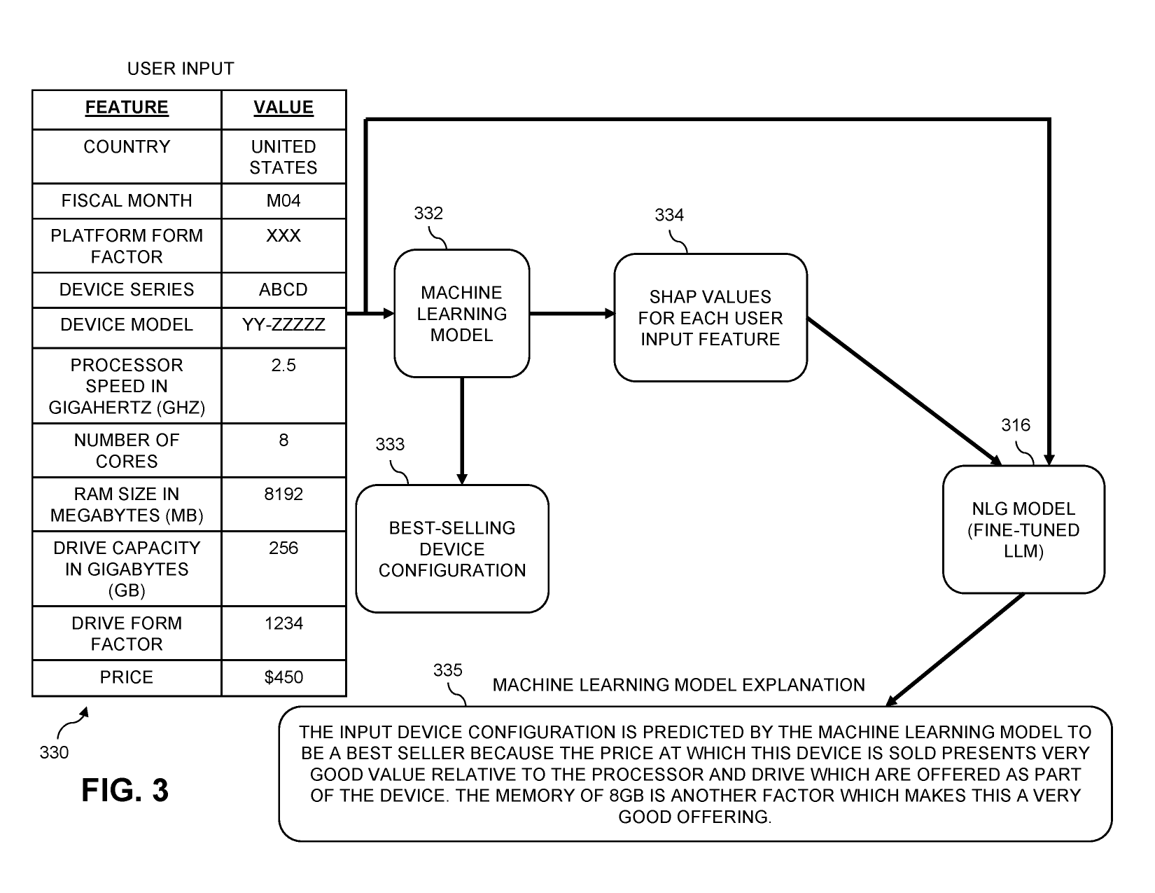

FIG. 3 shows an example use case involving an illustrative embodiment. By way of illustration, FIG. 3 depicts example user input 330, which includes device configuration parameters such as country, fiscal month, platform form factor, device series, device model, processor speed in gigahertz (GHz), number of cores, RAM size in megabytes (MB), drive capacity in gigabytes (GB), drive form factor, and price. The user input 330 is processed by machine learning model 332, which generates a prediction 333 that indicates that the device configurations of the user input 330 represent a best-selling device configuration. The machine learning model 332 output is also used to generate SHAP values 334 associated with the impact and/or influence of various device configuration parameters on the generated prediction 333.

As also depicted in FIG. 3, the SHAP values 334 are processed by NLG model 316 (e.g., by a fine-tuned LLM encompassed by and/or integrated with NLG model 316), in conjunction with the user input 330, to generate a machine learning model explanation 335 that can detail, for example, that “The input device configuration is predicted by the machine learning model to be a best seller because the price at which this device is sold presents very good value relative to the processor and drive which are offered as part of the device. The memory of approximately 8GB is another factor which makes this a very good offering.”

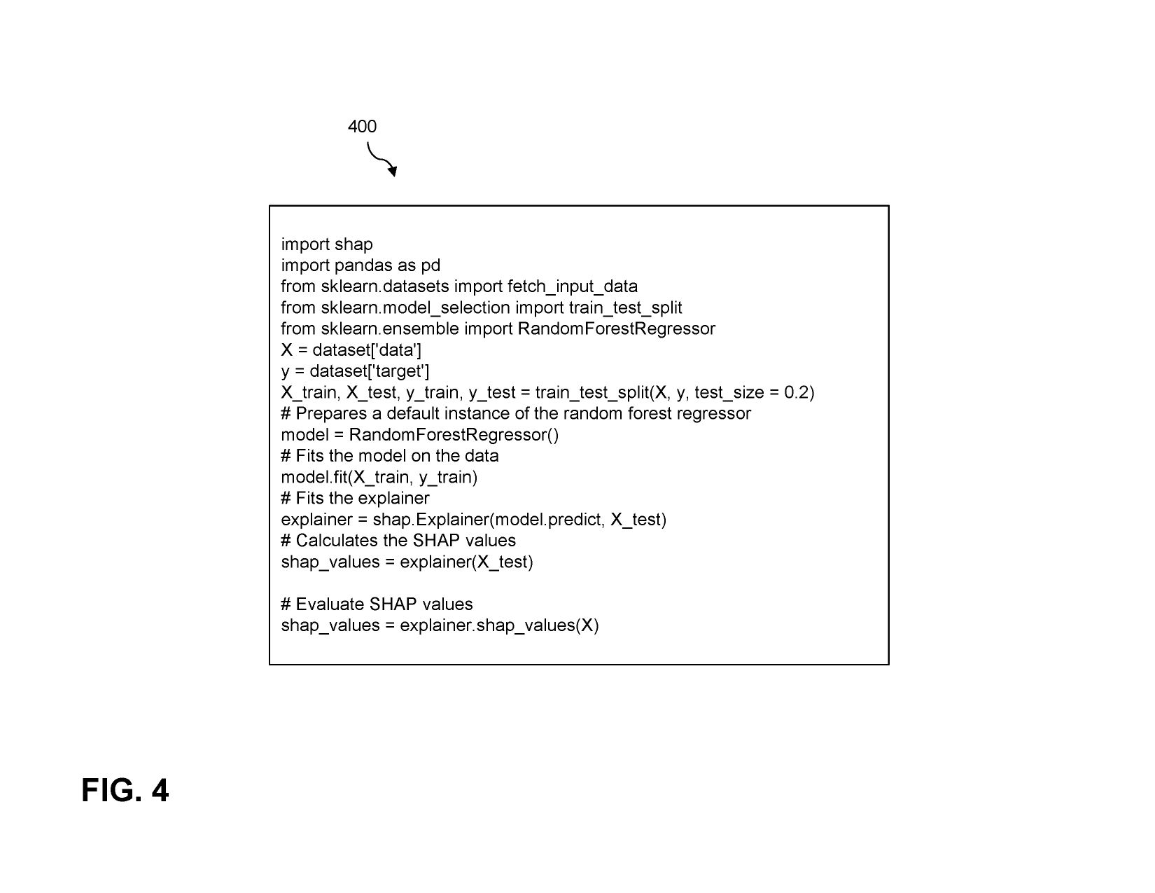

FIG. 4 shows example pseudocode for evaluating SHAP values in an illustrative embodiment. In this embodiment, example pseudocode 400 is executed by or under the control of at least one processing system and/or device. For example, the example pseudocode 400 may be viewed as comprising a portion of a software implementation of at least part of automated machine learning model output explainer system 105 of the FIG. 1 embodiment.

The example pseudocode 400 illustrates importing at least one Pandas library, importing input data from scikit-learn (sklearn) datasets, importing a train_test_split function from a sklearn model selection element, and importing a random forest regression from a sklearn ensemble. Additionally, example pseudocode 400 illustrates preparing a default instance of the random forest regressor, and fitting the random forest regressor on at least a portion of the input data. Also, example pseudocode 400 illustrates fitting an explainer related to SHAP values, calculating SHAP values using the explainer, and evaluating the SHAP values. In connection with example pseudocode 400, the explainer is a function of a SHAP library which can be used to generate SHAP values (e.g., feature importance values).

It is to be appreciated that this particular example pseudocode shows just one example implementation of evaluating SHAP values, and alternative implementations can be used in other embodiments.

As detailed herein, one or more embodiments include dynamic integration of SHAP values with at least one NLG model (e.g., at least one LLM), which enables and/or facilitates the automated generation of machine learning model output explanations tailored to one or more specific characteristics and/or nuances of each prediction. Additionally, at least one embodiment includes compatibility across various machine learning models, precluding a need for configuring and/or implementing model-specific adaptations.

Further, as described herein, at least one embodiment includes automatically generating human-readable explanations for machine learning model outputs, which can be leveraged to foster user trust and facilitate wider adoption of such machine learning models. Also, the corresponding emphasis on machine learning model transparency can contribute to responsible deployment of machine learning models by empowering users to comprehend and scrutinize the decisions made by such machine learning models, thereby promoting accountability and/or fairness.

It is to be appreciated that some embodiments described herein utilize one or more machine learning models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions explaining separate machine learning model output based on SHAP values related to input data for the separate machine learning model, and such recommendations and/or predictions can be used to initiate one or more automated actions (e.g., automatically outputting and/or displaying the machine learning model explanation(s) to at least one user, automatically retraining the separate model, initiating one or more output-related actions via one or more external and/or separate systems, automatically modifying at least a portion of the machine learning output, etc.).

FIG. 5 is a flow diagram of a process for generating machine learning model output explanations using artificial intelligence techniques in an illustrative embodiment. It is to be understood that this particular process is only an example, and additional or alternative processes can be carried out in other embodiments.

In this embodiment, the process includes steps 500 through 506. These steps are assumed to be performed by the automated machine learning model output explainer system 105 utilizing elements 112, 114, 116 and 118.

Step 500 includes obtaining at least one machine learning model output generated by processing at least one set of user input data. Step 502 includes generating one or more values attributed to the at least one machine learning model output, wherein each of the one or more values indicate a relative impact of a given variable, among one or more variables, on the at least one machine learning model output. In at least one embodiment, generating one or more values attributed to the at least one machine learning model output includes generating one or more SHAP values attributed to the at least one machine learning model output, wherein each of the one or more SHAP values indicate a relative impact of a given variable, among the one or more variables, on the at least one machine learning model output. In such an embodiment, generating one or more SHAP values attributed to the at least one machine learning model output can include processing at least a portion of the at least one set of user input data and at least a portion of the at least one machine learning model output using at least one SHAP library. Also, in at least one embodiment, the one or more variables can include one or more machine learning model input features related to the at least one machine learning model output.

Step 504 includes generating at least one explanation of the at least one machine learning model output by processing at least a portion of one or more data structures comprising the one or more generated values, using one or more artificial intelligence techniques. In one or more embodiments, generating at least one explanation of the at least one machine learning model output includes processing the at least a portion of one or more data structures using at least one LLM fine-tuned using at least a portion of the set of user input data and at least a portion of the one or more values attributed to the at least one machine learning model output.

Additionally or alternatively, generating at least one explanation of the at least one machine learning model output can include mapping the one or more generated values against one or more respective input features of the machine learning model associated with the at least one machine learning model output, and ranking the one or more respective input features of the machine learning model on a basis of most relative impact on the at least one machine learning model output to least relative impact on the at least one machine learning model output. Further, in one or more embodiments, generating at least one explanation of the at least one machine learning model output can include processing the at least a portion of one or more data structures using at least one NLG model.

Step 506 includes performing one or more automated actions based at least in part on the at least one generated explanation of the at least one machine learning model output. In at least one embodiment, performing one or more automated actions includes automatically outputting at least a portion of the at least one generated explanation of the at least one machine learning model output to at least one user device using at least one application programming interface. In such an embodiment, automatically outputting at least a portion of the at least one generated explanation of the at least one machine learning model output to at least one user device can include automatically outputting the at least a portion of the at least one generated explanation of the at least one machine learning model output to at least one user device associated with submission of the at least one set of user input data. Additionally or alternatively, performing one or more automated actions can include automatically training at least a portion of the machine learning model associated with the at least one machine learning model output using feedback related to at least a portion of the at least one generated explanation of the at least one machine learning model output.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically generate machine learning model output explanations using artificial intelligence techniques. These and other embodiments can effectively overcome problems associated with undermining user confidence and/or user trust in machine learning models.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

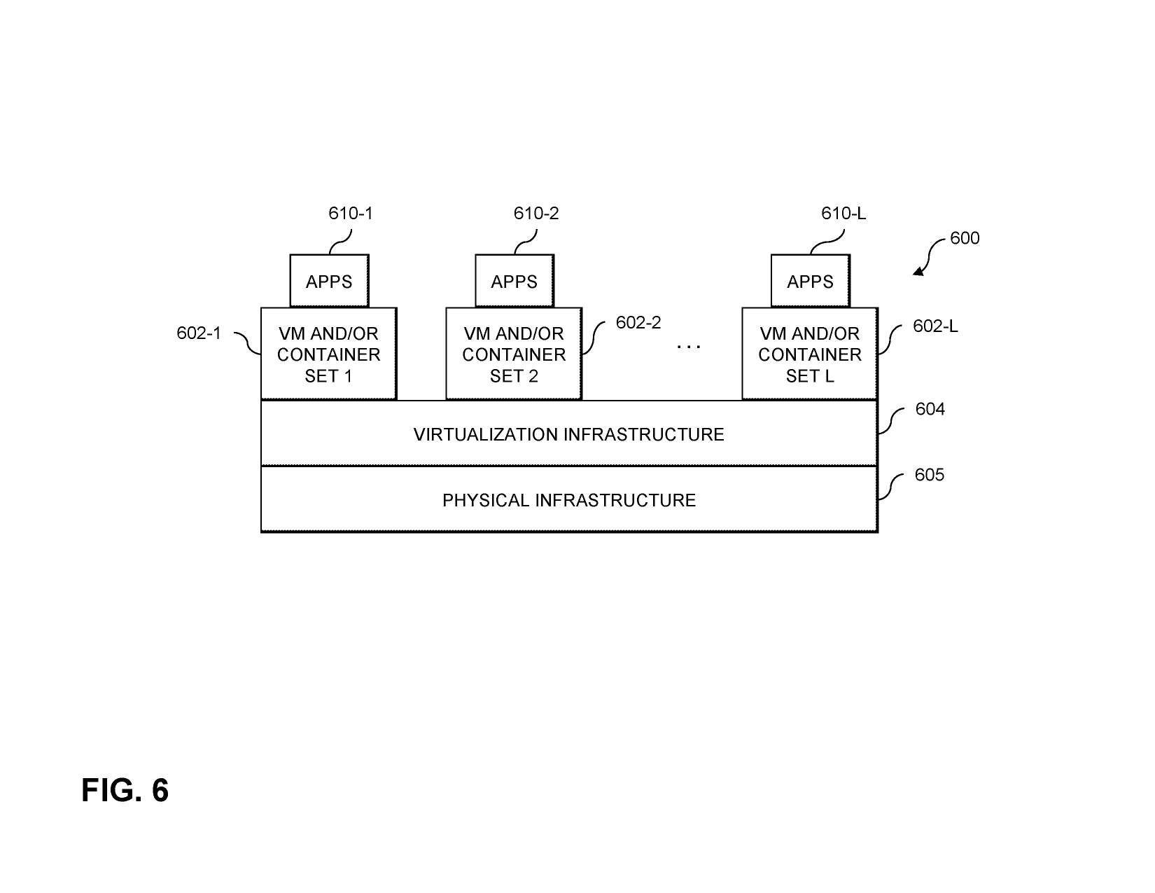

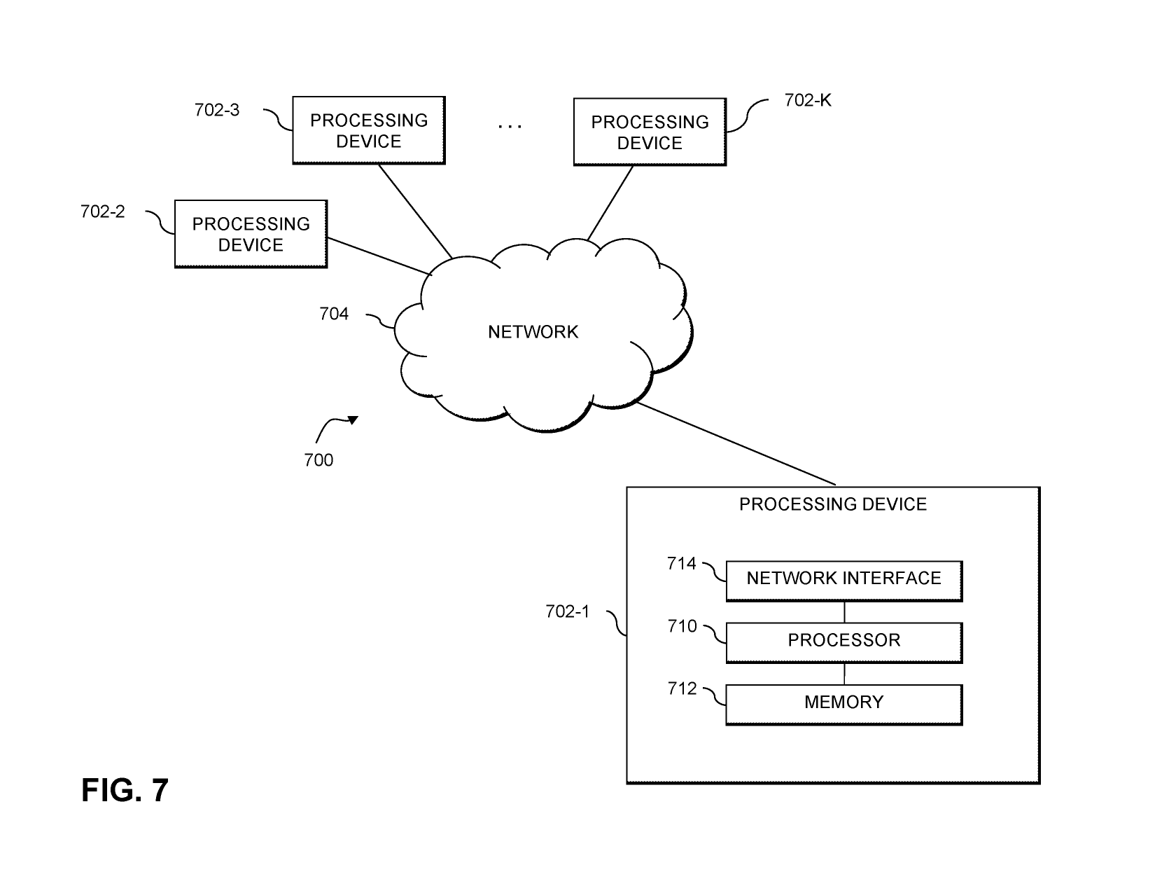

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more information processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a CPU, a GPU, a TPU, a microcontroller, an ASIC, a FPGA or other type of processing circuitry, as well as portions or combinations of such circuitry elements.

The memory 712 comprises RAM, ROM or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining at least one machine learning model output generated by processing at least one set of user input data;
generating one or more values attributed to the at least one machine learning model output, wherein each of the one or more values indicate a relative impact of a given variable, among one or more variables, on the at least one machine learning model output;
generating at least one explanation of the at least one machine learning model output by processing at least a portion of one or more data structures comprising the one or more generated values, using one or more artificial intelligence techniques; and
performing one or more automated actions based at least in part on the at least one generated explanation of the at least one machine learning model output;
wherein the method is performed by at least one processing device comprising a processor coupled to a memory.

2. The computer-implemented method of claim 1, wherein generating one or more values attributed to the at least one machine learning model output comprises generating one or more Shapley (SHAP) values attributed to the at least one machine learning model output, wherein each of the one or more SHAP values indicate a relative impact of a given variable, among the one or more variables, on the at least one machine learning model output.

3. The computer-implemented method of claim 2, wherein generating one or more SHAP values attributed to the at least one machine learning model output comprises processing at least a portion of the at least one set of user input data and at least a portion of the at least one machine learning model output using at least one SHAP library.

4. The computer-implemented method of claim 1, wherein generating at least one explanation of the at least one machine learning model output comprises processing the at least a portion of one or more data structures using at least one large language model (LLM) fine-tuned using at least a portion of the set of user input data and at least a portion of the one or more values attributed to the at least one machine learning model output.

5. The computer-implemented method of claim 1, wherein generating at least one explanation of the at least one machine learning model output comprises:
mapping the one or more generated values against one or more respective input features of the machine learning model associated with the at least one machine learning model output; and
ranking the one or more respective input features of the machine learning model on a basis of most relative impact on the at least one machine learning model output to least relative impact on the at least one machine learning model output.

6. The computer-implemented method of claim 1, wherein performing one or more automated actions comprises automatically outputting at least a portion of the at least one generated explanation of the at least one machine learning model output to at least one user device using at least one application programming interface.

7. The computer-implemented method of claim 6, wherein automatically outputting at least a portion of the at least one generated explanation of the at least one machine learning model output to at least one user device comprises automatically outputting the at least a portion of the at least one generated explanation of the at least one machine learning model output to at least one user device associated with submission of the at least one set of user input data.

8. The computer-implemented method of claim 1, wherein performing one or more automated actions comprises automatically training at least a portion of the machine learning model associated with the at least one machine learning model output using feedback related to at least a portion of the at least one generated explanation of the at least one machine learning model output.

9. The computer-implemented method of claim 1, wherein generating at least one explanation of the at least one machine learning model output comprises processing the at least a portion of one or more data structures using at least one natural language generation (NLG) model.

10. The computer-implemented method of claim 1, wherein the one or more variables comprise one or more machine learning model input features related to the at least one machine learning model output.

11. A non-transitory processor-readable storage medium having stored therein program code of one or more software programs, wherein the program code when executed by at least one processing device causes the at least one processing device:
to obtain at least one machine learning model output generated by processing at least one set of user input data;
to generate one or more values attributed to the at least one machine learning model output, wherein each of the one or more values indicate a relative impact of a given variable, among one or more variables, on the at least one machine learning model output;
to generate at least one explanation of the at least one machine learning model output by processing at least a portion of one or more data structures comprising the one or more generated values, using one or more artificial intelligence techniques; and
to perform one or more automated actions based at least in part on the at least one generated explanation of the at least one machine learning model output.

12. The non-transitory processor-readable storage medium of claim 11, wherein generating one or more values attributed to the at least one machine learning model output comprises generating one or more Shapley (SHAP) values attributed to the at least one machine learning model output, wherein each of the one or more SHAP values indicate a relative impact of a given variable, among the one or more variables, on the at least one machine learning model output.

13. The non-transitory processor-readable storage medium of claim 12, wherein generating one or more SHAP values attributed to the at least one machine learning model output comprises processing at least a portion of the at least one set of user input data and at least a portion of the at least one machine learning model output using at least one SHAP library.

14. The non-transitory processor-readable storage medium of claim 11, wherein generating at least one explanation of the at least one machine learning model output comprises processing the at least a portion of one or more data structures using at least one large language model (LLM) fine-tuned using at least a portion of the set of user input data and at least a portion of the one or more values attributed to the at least one machine learning model output.

15. The non-transitory processor-readable storage medium of claim 11, wherein performing one or more automated actions comprises automatically outputting at least a portion of the at least one generated explanation of the at least one machine learning model output to at least one user device using at least one application programming interface.

16. An apparatus comprising:
at least one processing device comprising a processor coupled to a memory;
the at least one processing device being configured:
to obtain at least one machine learning model output generated by processing at least one set of user input data;
to generate one or more values attributed to the at least one machine learning model output, wherein each of the one or more values indicate a relative impact of a given variable, among one or more variables, on the at least one machine learning model output;
to generate at least one explanation of the at least one machine learning model output by processing at least a portion of one or more data structures comprising the one or more generated values, using one or more artificial intelligence techniques; and
to perform one or more automated actions based at least in part on the at least one generated explanation of the at least one machine learning model output.

17. The apparatus of claim 16, wherein generating one or more values attributed to the at least one machine learning model output comprises generating one or more Shapley (SHAP) values attributed to the at least one machine learning model output, wherein each of the one or more SHAP values indicate a relative impact of a given variable, among the one or more variables, on the at least one machine learning model output.

18. The apparatus of claim 17, wherein generating one or more SHAP values attributed to the at least one machine learning model output comprises processing at least a portion of the at least one set of user input data and at least a portion of the at least one machine learning model output using at least one SHAP library.

19. The apparatus of claim 16, wherein generating at least one explanation of the at least one machine learning model output comprises processing the at least a portion of one or more data structures using at least one large language model (LLM) fine-tuned using at least a portion of the set of user input data and at least a portion of the one or more values attributed to the at least one machine learning model output.

20. The apparatus of claim 16, wherein performing one or more automated actions comprises automatically outputting at least a portion of the at least one generated explanation of the at least one machine learning model output to at least one user device using at least one application programming interface.
